(19) United States
(12) Patent Application Publication
(10) Pub. No.: US 2012/0133829 A1
(43) Pub. Date: May 31, 2012

(54) VIDEO DISPLAY APPARATUS AND VIDEO DISPLAY METHOD, AUDIO REPRODUCTION APPARATUS AND AUDIO REPRODUCTION METHOD, AND VIDEO/AUDIO SYNCHRONOUS CONTROL SYSTEM

(75) Inventor: Tomoaki NAKADE, Fukaya-shi (JP)

(73) Assignee: KABUSHIKI KAISHA TOSHIBA, Tokyo (JP)

(21) Appl. No.: 13/300,383

(22) Filed: Nov. 18, 2011

(30) Foreign Application Priority Data
Nov. 30, 2010 (JP) 2010-267577

(51) Int. Cl. H04N 9/475

(52) U.S. Cl. 348/515; 348/E09.034

(57) ABSTRACT

According to one embodiment, a video display apparatus includes a generation module and a transmitting module. The generation module is configured to generate, when an operation mode change that changes the time required for video signal processing is requested, a device control signal in which information indicating the time required for video signal processing in the requested operation mode is written. The transmitting module is configured to transmit the device control signal generated by the generation module via a transmission line of the device control signal to cause an audio reproduction apparatus to set a delay amount of audio reproduction.

### CROSS-REFERENCE TO RELATED APPLICATIONS

This application is based upon and claims the benefit of priority from prior Japanese Patent Application No. 2010-267577, filed Nov. 30, 2010, the entire contents of which are incorporated herein by reference.

### FIELD

Embodiments described herein relate generally to a video display apparatus and video display method, an audio reproduction apparatus and audio reproduction method, and a video/audio synchronization control system.

### BACKGROUND

As is well known, the digital visual interface (DVI) standard is widely used as a standard to transmit a digital video signal. In recent years, the high definition multimedia interface (HDMI) that further improves the DVI standard is increasingly adopted as a digital signal transmission standard.

For example, in addition to being able to transmit audio by multiplexing a digital audio signal in a blanking period of a digital video signal and transmitting the digital video signal in the form of an RGB signal, the HDMI standard includes various specifications that are not included in the DVI standard such as being able to transmit in the form of a YCbCr signal or in the form of a YPbPr signal in still higher quality and being able to transmit by an HDMI connector like a universal serial bus (USB).

According to the HDMI standard, by performing authentication between a device on the transmitting side and a device on the receiving side, the device on the transmitting side can output a signal in the form adjusted to performance of the device on the receiving side. That is, the device on the transmitting side can recognize receiving specifications of the device on the receiving side and output a signal in the form adjusted thereto by acquiring extended display identification (EDID) data from the device on the receiving side.

By using digital signal transmission conforming to the HDMI standard, for example, the form of usage can be taken in which, as regards a video signal and an audio signal in digital form output mutually synchronously from an information output apparatus such as an optical disk reproduction apparatus, the audio signal is transmitted to an audio reproduction apparatus (commonly named an AV amplifier) for audio reproduction and the video signal is transmitted to a digital television broadcast-receiving apparatus for the video display.

In this case, the audio reproduction apparatus acquires time information required for video signal processing stored inside the digital television broadcast-receiving apparatus as EDID data and delays the audio signal by the time indicated by the time information for audio reproduction. Accordingly, the reproduced audio by the audio reproduction apparatus and the displayed video by the digital television broadcast-receiving apparatus can be synchronized.

Incidentally, the digital television broadcast-receiving apparatus has various video display modes, for example, “Standard mode”, “Movie mode”, and “Game mode” prepared in accordance with the type of video to be displayed and the time required for video signal processing differs according to the video display mode. However, EDID data is stored inside the digital television broadcast-receiving apparatus as a fixed value, and thus the time required for video signal processing in accordance with each video display mode cannot be currently provided to the audio reproduction apparatus.

The EDID data stored in the digital television broadcast-receiving apparatus and indicating the time required for video signal processing may be changed in response to switching of the video display mode. In such a case, however, each time the EDID data is changed, it becomes necessary to mutually perform authentication processing again between the digital television broadcast-receiving apparatus and audio reproduction apparatus and no video is displayed during a period of the authentication processing (for example, about 10 seconds), resulting in inconvenience of handling for the user.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block configuration diagram for schematically illustrating an example of a video/audio synchronous reproduction system according to an embodiment;

FIG. 2 is a block configuration diagram for illustrating an example of a signal processing system of an optical disk reproduction apparatus constituting the video/audio synchronous reproduction system according to the embodiment;

FIG. 3 is a block configuration diagram for illustrating an example of the signal processing system of a digital television broadcast-receiving apparatus constituting the video/audio synchronous reproduction system according to the embodiment;

FIG. 4 is a block configuration diagram for illustrating an example of the signal processing system of an audio reproduction apparatus constituting the video/audio synchronous reproduction system according to the embodiment;

FIG. 5 is a flowchart for illustrating an example of a main processing operation performed by the digital television broadcast-receiving apparatus according to the embodiment;

FIG. 6 is a flowchart for illustrating an example of a main processing operation performed by the audio reproduction apparatus according to the embodiment;

FIG. 7 is a flowchart for illustrating another example of the main processing operation performed by the audio reproduction apparatus according to the embodiment; and

FIG. 8 is a flowchart for illustrating another example of the main processing operation performed by the digital television broadcast-receiving apparatus according to the embodiment.

### DETAILED DESCRIPTION

Various embodiments will be described hereinafter with reference to the accompanying drawings. In general, according to one embodiment, a video display apparatus includes a generation module and a transmitting module. The generation module is configured to generate, when an operation mode change that changes the time required for video signal processing is requested, a device control signal in which information indicating the time required for video signal processing in the requested operation mode is written. The transmitting module is configured to transmit the device control signal generated by the generation module via a transmission line of the device control signal to cause an audio reproduction apparatus to set a delay amount of audio reproduction.

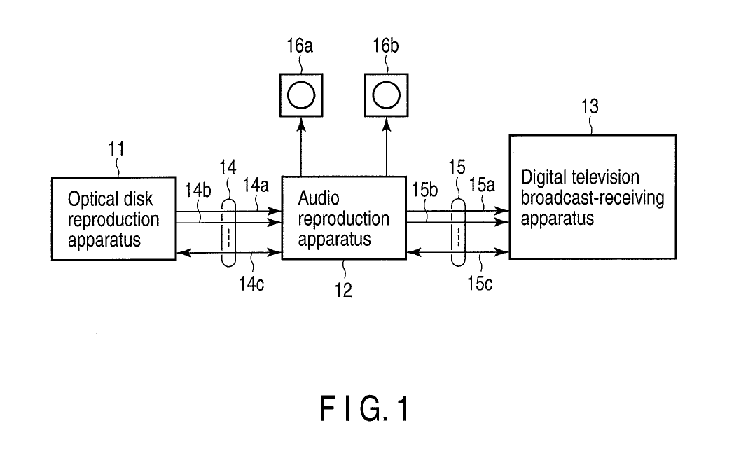

FIG. 1 schematically shows an example of a video/audio synchronous reproduction system described in the embodiment. That is, the video/audio synchronous reproduction system includes, for example, an optical disk reproduction apparatus 11, which is an information output apparatus such as a digital versatile disk (DVD) player, an audio reproduction apparatus 12 such as an AV amplifier, and a digital television broadcast-receiving apparatus 13, which is a video display apparatus.

Of these apparatuses, the optical disk reproduction apparatus 11 and the audio reproduction apparatus 12 are connected by an HDMI cable 14 such that a digital signal can be transmitted based on the HDMI standard. Also, the audio reproduction apparatus 12 and the digital television broadcast-receiving apparatus 13 are connected by an HDMI cable 15 such that a digital signal can be transmitted based on the HDMI standard.

The HDMI cables 14, 15 of the standard type normally contain a dozen or so lines, and lines necessary for describing the embodiment, that is, video lines 14a and 15a, audio lines 14b and 15b, and consumer electronics control (CEC) lines 14c and 15c will be described below.

First, a digital video signal reproduced by the optical disk reproduction apparatus 11 is fed to the digital television broadcast-receiving apparatus 13 via the video line 14a of the HDMI cable 14, the audio reproduction apparatus 12, and the video line 15a of the HDMI cable 15 before being delivered for the video display.

A digital audio signal reproduced by the optical disk reproduction apparatus 11 is fed to the audio reproduction apparatus 12 via the audio line 14b of the HDMI cable 14 before being delivered for audio reproduction by a pair of speakers 16a and 16b.

Further, the CEC lines 14c and 15c of the HDMI cables 14 and 15 are lines controlling transmission of device control signals based on a control protocol defined for the HDMI standard. That is, the optical disk reproduction apparatus 11, the audio reproduction apparatus 12, and the digital television broadcast-receiving apparatus 13 transmit a device control signal via the CEC lines 14c and 15c to be able to mutually control other apparatuses to a predetermined operation state or a stopped state.

The digital television broadcast-receiving apparatus 13 feeds information indicating the time required for video signal processing thereby, that is, a LipSync value, which is information to synchronize the reproduced audio by the audio reproduction apparatus 12 with display video thereof, to the audio reproduction apparatus 12 via the CEC line 15c.

That is, the digital television broadcast-receiving apparatus 13 transmits a delay amount setting command, for example, <Set LipSync time>[300 ms] as <Vender Command> defined in the device control signal to the audio reproduction apparatus 12 via the CEC line 15c. The delay amount setting command has content to make a request to the audio reproduction apparatus 12 to set the LipSync value, that is, the delay amount of an audio signal to 300 ms.

In short, the digital television broadcast-receiving apparatus 13 has various video display modes, for example, “Standard mode”, “Movie mode”, and “Game mode” prepared in accordance with the type of video to be displayed and the time required for video signal processing differs according to the video display mode. Thus, the digital television broadcast-receiving apparatus 13 feeds a delay amount setting command in which the video signal processing time in accordance with the set video display mode is written in [ ] to the audio reproduction apparatus 12 via the CEC line 15c.

When a device control signal is fed from the digital television broadcast-receiving apparatus 13 via the CEC line 15c, the audio reproduction apparatus 12 determines whether the device control signal is a delay amount setting command and if the device control signal is a delay amount setting command, sets the time written inside [ ] as the delay amount of an audio signal.

As described above, the video display mode is changed by information indicating the time required for video signal processing by the digital television broadcast-receiving apparatus 13 being transmitted to the audio reproduction apparatus 12 as a command defined for the device control signal transmitted via the CEC line 15c. Even if the time required for video signal processing is changed, the changed time can be transmitted to the audio reproduction apparatus 12. Accordingly, the audio reproduction apparatus 12 can synchronize the reproduced audio with the display video by delaying the reproduced audio in accordance with the changed time, making the handling convenient for the user to suit practical use.

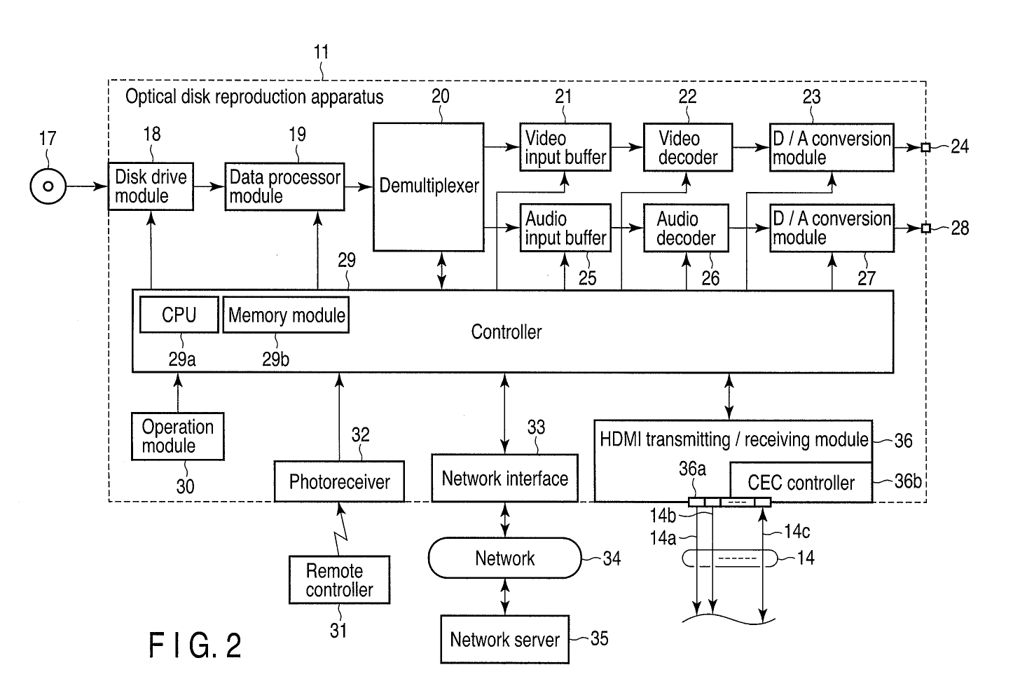

FIG. 2 schematically shows a signal processing system of the optical disk reproduction apparatus 11. The optical disk reproduction apparatus 11 includes a disk drive module 18 into which an optical disk 17, for example, a DVD is inserted to read data recorded therein. Data read by the disk drive module 18 is fed to a demultiplexer 20 via a data processor module 19. The demultiplexer 20 separates input data into a video signal and an audio signal in digital form.

The digital video signal of these signals undergoes decode processing by being fed to a video decoder 22 via a video input buffer 21. Then, the decoded video signal is fed to a digital/analog (D/A) conversion module 23 for conversion into an analog video signal, which is fetched to the outside via a video output terminal 24.

The digital audio signal separated by the demultiplexer 20 is fed to an audio decoder 26 via an audio input buffer 25 to undergo decode processing. Then, the decoded audio signal is fed to a D/A conversion module 27 for conversion into an analog audio signal, which is fetched to the outside via an audio output terminal 28.

In this case, in the optical disk reproduction apparatus 11, a controller 29 centrally controls all operations including the reproduction operation of the optical disk 17 as described above. The controller 29 contains a central processing unit (CPU) 29a and, upon receipt of operation information obtained from an operation module 30 installed in the main body of the optical disk reproduction apparatus 11 or operation information received by a photoreceiver 32 after being transmitted from a remote controller 31, controls each module so that content of the operation is reflected.

In this case, the controller 29 mainly uses a memory module 29b. The memory module 29b includes a read only memory (ROM) storing a control program executed by the CPU 29a, a random access memory (RAM) providing a work area to the CPU 29a, and a nonvolatile memory in which various kinds of setting information and control information are stored.

The controller 29 is connected to an external network 34 via a network interface 33. Thus, the controller 29 accesses a network server 35 in the network 34 based on an operation of the operation module 30 or the remote controller 31 by the user so that various services provided there can be used.

Further, the controller 29 is connected to an HDMI transmitting/receiving module 36. One end of the HDMI cable 14 is connected to the HDMI transmitting/receiving module 36 via a connector 36a. Then, based on the operation of the operation module 30 or the remote controller 31 by the user, the controller 29 feeds the digital video signal and audio signal separated by the demultiplexer 20 to the HDMI transmitting/receiving module 36.

As a result, the HDMI transmitting/receiving module 36 converts the input digital video signal and audio signal into signals in a form conforming to the HDMI standard and delivers the converted signals to the video line 14a and the audio line 14b of the HDMI cable 14 via the connector 36a. Accordingly, the digital video signal and audio signal reproduced by the optical disk reproduction apparatus 11 are transmitted to the audio reproduction apparatus 12 and the digital television broadcast-receiving apparatus 13 via the HDMI cables 14 and 15.

The controller 29 also generates a control signal for other apparatuses (in this case, the audio reproduction apparatus 12 and the digital television broadcast-receiving apparatus 13) connected conforming to the HDMI standard based on the operation of the operation module 30 or the remote controller 31 by the user and feeds the control signal to the HDMI transmitting/receiving module 36.

As a result, the HDMI transmitting/receiving module 36 converts the input control signal into a device control signal in the form conforming to the HDMI standard through a CEC controller 36b and delivers the device control signal to the CEC line 14c of the HDMI cable 14 via the connector 36a. Accordingly, device control signals generated by the optical disk reproduction apparatus 11 are transmitted to the audio reproduction apparatus 12 and the digital television broadcast-receiving apparatus 13 via the HDMI cables 14 and 15 so that these apparatuses can be controlled.

Conversely, a device control signal output from the audio reproduction apparatus 12 or the digital television broadcast-receiving apparatus 13 and fed to the connector 36a via the CEC line 14c is analyzed by the CEC controller 36b and converted into a form of control signal to control the optical disk reproduction apparatus 11 before being fed to the controller 29.

Accordingly, upon receipt of a control signal fed from the CEC controller 36b, the controller 29 controls each module so that content of the control is reflected and here, the optical disk reproduction apparatus 11 is controlled by the device control signal output by the audio reproduction apparatus 12 or the digital television broadcast-receiving apparatus 13.

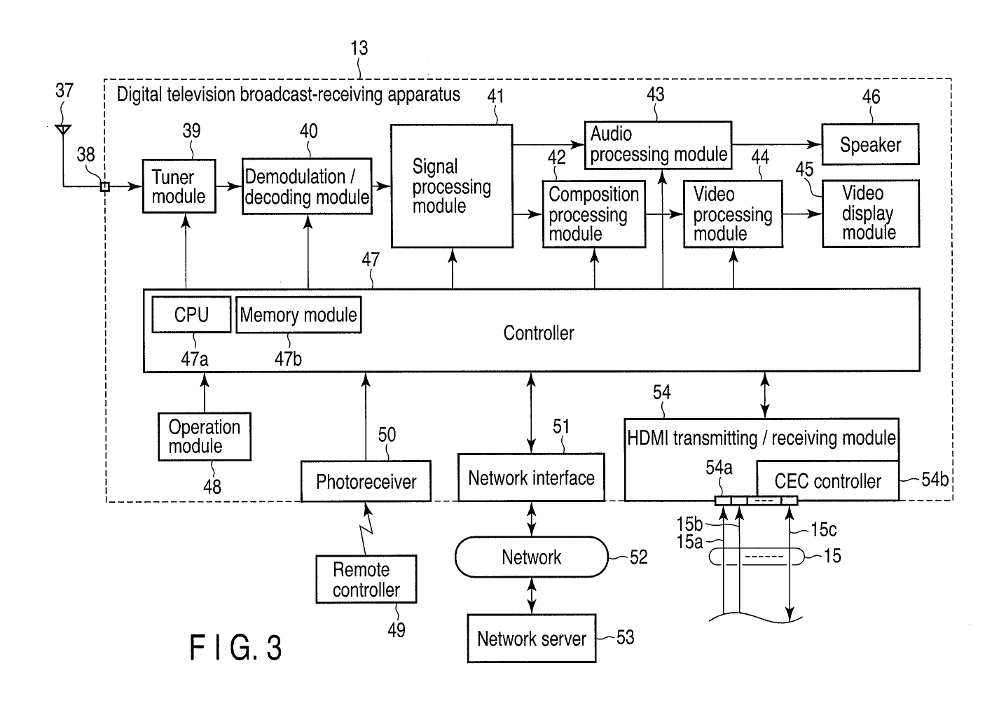

FIG. 3 schematically shows the signal processing system of the digital television broadcast-receiving apparatus 13. That is, a digital television broadcasting signal received by an antenna 37 is fed to a tuner module 39 via an input terminal 38 to be tuned in to a broadcasting signal of a desired channel.

Then, the broadcasting signal tuned in to by the tuner module 39 is fed to a demodulation/decoding module 40 to restore the digital video signal and audio signal, which are then output to a signal processing module 41. The signal processing module 41 performs predetermined digital signal processing on the digital video signal and audio signal fed from the demodulation/decoding module 40.

Examples of the predetermined digital signal processing performed by the signal processing module 41 include various kinds of video signal processing in accordance with the set video display mode, processing to convert a video signal for plane (two-dimensional) display into a video signal for stereoscopic (three-dimensional) display, processing to convert a video signal for stereoscopic (three-dimensional) display into a video signal for plane (two-dimensional) display, and quad-speed reproduction processing.

The signal processing module 41 outputs a digital video signal to a composition processing module 42 and a digital audio signal to an audio processing module 43. Of these modules, the composition processing module 42 superimposes an on screen display (OSD) signal on a digital video signal fed from the signal processing module 41 before outputting the digital video signal.

In this case, if the video signal fed from the signal processing module 41 is a common video signal for plane (two-dimensional) display, the composition processing module 42 directly superimposes an OSD signal on the video signal and then outputs the video signal. If the video signal fed from the signal processing module 41 is a video signal for stereoscopic (three-dimensional) display, the composition processing module 42 performs signal processing for stereoscopic (three-dimensional) display corresponding to the input video signal for stereoscopic (three-dimensional) display on an OSD signal to be superimposed and then superimposes the OSD signal on the input video signal and outputs the video signal.

The digital video signal output from the composition processing module 42 in this manner is fed to a video processing module 44 and is converted into a format that can be displayed by a flat video display module 45 including, for example, a liquid crystal display panel in the subsequent stage. Then, the video signal output from the video processing module 44 is delivered for video display by being fed to the video display module 45.

The audio processing module 43 converts the input digital audio signal into an analog audio signal in a format that can be reproduced by a speaker 46 in the subsequent stage. Then, the analog audio signal output from the audio processing module 43 is delivered for audio reproduction by being fed to the speaker 46.

In this case, in the digital television broadcast-receiving apparatus 13, a controller 47 centrally controls all operations including various kinds of reception operations as described above. The controller 47 contains a CPU 47a and, upon receipt of operation information obtained from an operation module 48 installed in the main body of the digital television broadcast-receiving apparatus 13 or operation information received by a photoreceiver 50 after being transmitted from a remote controller 49, controls each module so that content of the operation is reflected.

In this case, the controller 47 mainly uses a memory module 47b. The memory module 47b includes a ROM storing a control program executed by the CPU 47a, a RAM providing a work area to the CPU 47a, and a nonvolatile memory in which various kinds of setting information and control information are stored.

The controller 47 is connected to an external network 52 via a network interface 51. Thus, the controller 47 accesses a network server 53 in the network 52 based on an operation of the operation module 48 or the remote controller 49 by the user so that various services provided there can be used.

Further, the controller 47 is connected to an HDMI transmitting/receiving module 54. One end of the HDMI cable 15 is connected to the HDMI transmitting/receiving module 54 via a connector 54a. A digital video signal reproduced by the optical disk reproduction apparatus 11 is fed to the HDMI transmitting/receiving module 54 of the digital television broadcast-receiving apparatus 13 via the video line 14a of the HDMI cable 14, the audio reproduction apparatus 12, the video line 15a of the HDMI cable 15, and the connector 54a.

A digital audio signal reproduced by the optical disk reproduction apparatus 11 is fed to the HDMI transmitting/receiving module 54 of the digital television broadcast-receiving apparatus 13 via the audio line 14b of the HDMI cable 14, the audio reproduction apparatus 12, the audio line 15b of the HDMI cable 15, and the connector 54a.

The HDMI transmitting/receiving module 54 decodes the input digital video signal and audio signal from a form conforming to the HDMI standard and feeds the decoded video signal and audio signal to the controller 47. As a result, based on the operation of the operation module 48 or the remote controller 49 by the user, the controller 47 exercises control so that the video signal and audio signal are delivered for the video display and audio reproduction by feeding the video signal and audio signal fed from the HDMI transmitting/receiving module 54 to the signal processing module 41.

Accordingly, the digital video signal and audio signal reproduced by the optical disk reproduction apparatus 11 are transmitted to the digital television broadcast-receiving apparatus 13 via the HDMI cables 14 and 15 before being delivered for video display and audio reproduction. When the audio is reproduced by the audio reproduction apparatus 12, the audio reproduction by the speaker 46 of the digital television broadcast-receiving apparatus 13 is commonly muted.

The controller 47 also generates a control signal for other apparatuses (in this case, the optical disk reproduction apparatus 11 and the audio reproduction apparatus 12) connected conforming to the HDMI standard based on the operation of the operation module 48 or the remote controller 49 by the user and feeds the control signal to the HDMI transmitting/receiving module 54.

As a result, the HDMI transmitting/receiving module 54 converts the input control signal into a device control signal in the form conforming to the HDMI standard through a CEC controller 54b and delivers the device control signal to the CEC line 15c of the HDMI cable 15 via the connector 54a. Accordingly, device control signals generated by the digital television broadcast-receiving apparatus 13 are transmitted to the optical disk reproduction apparatus 11 and the audio reproduction apparatus 12 via the HDMI cables 14 and 15 so that these apparatuses can be controlled.

Conversely, a device control signal output from the optical disk reproduction apparatus 11 or the audio reproduction apparatus 12 and fed to the connector 54a via the CEC line 15c is analyzed by the CEC controller 54b and converted into a form of control signal to control the digital television broadcast-receiving apparatus 13 before being fed to the controller 47.

Accordingly, upon receipt of a control signal fed from the CEC controller 54b, the controller 47 controls each module so that content of the control is reflected and here, the digital television broadcast-receiving apparatus 13 is controlled by the device control signal output by the optical disk reproduction apparatus 11 or the audio reproduction apparatus 12.

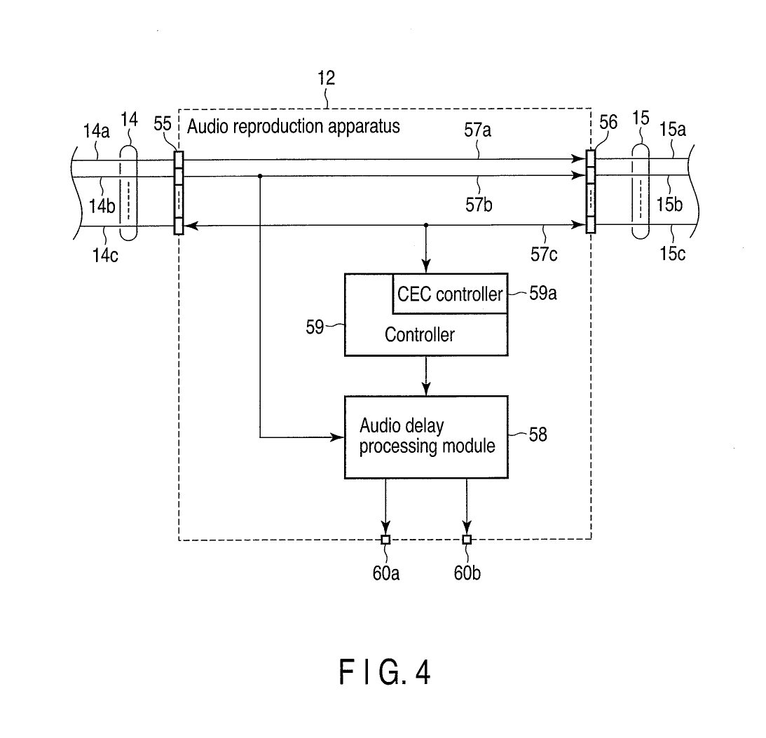

FIG. 4 schematically shows the signal processing system of the audio reproduction apparatus 12. The audio reproduction apparatus 12 includes a connector 55 to which the other end of the HDMI cable 14 is connected and a connector 56 to which the other end of the HDMI cable 15 is connected. Inside the audio reproduction apparatus 12, the two connectors 55, 56 enable mutual connection of each line held by the HDMI cable 14 and each line held by the HDMI cable 15 corresponding thereto.

That is, a digital video signal output to the video line 14a of the HDMI cable 14 from the optical disk reproduction apparatus 11 is transmitted to the video line 15a of the HDMI cable 15 via the connector 55 of the audio reproduction apparatus 12, a video line 57a, and the connector 56 before being fed to the digital television broadcast-receiving apparatus 13.

Also, a digital audio signal output to the audio line 14b of the HDMI cable 14 from the optical disk reproduction apparatus 11 is transmitted to the audio line 15b of the HDMI cable 15 via the connector 55 of the audio reproduction apparatus 12, an audio line 57b, and the connector 56 before being fed to the digital television broadcast-receiving apparatus 13.

Further, a device control signal output to the CEC line 14c of the HDMI cable 14 from the optical disk reproduction apparatus 11 is transmitted to the CEC line 15c of the HDMI cable 15 via the connector 55 of the audio reproduction apparatus 12, a CEC line 57c, and the connector 56 before being fed to the digital television broadcast-receiving apparatus 13.

Also, a device control signal output to the CEC line 15c of the HDMI cable 15 from the digital television broadcast-receiving apparatus 13 is transmitted to the CEC line 14c of the HDMI cable 14 via the connector 56 of the audio reproduction apparatus 12, the CEC line 57c, and the connector 55 before being fed to the optical disk reproduction apparatus 11.

An audio signal transmitted over the audio line 57b inside the audio reproduction apparatus 12 is fed to an audio delay processing module 58. The audio delay processing module 58 delays the input audio signal based on a delay amount fed from a controller 59 and converts the delayed audio signal into analog form and amplifies the analog signal before being output to the speakers 16a, 16b via a pair of audio output terminals 60a, 60b.

Then, a device control signal transmitted over the CEC line 57c inside the audio reproduction apparatus 12 is fed to the controller 59. The device control signal fed to the controller 59 is analyzed by a CEC controller 59a. The CEC controller 59a determines whether the input device control signal is the delay amount setting command and, if the device control signal is the delay amount setting command, acquires the time written inside [ ] thereof. Then, the controller 59 outputs the time acquired by the CEC controller 59a to the audio delay processing module 58 as the delay amount of the audio signal.

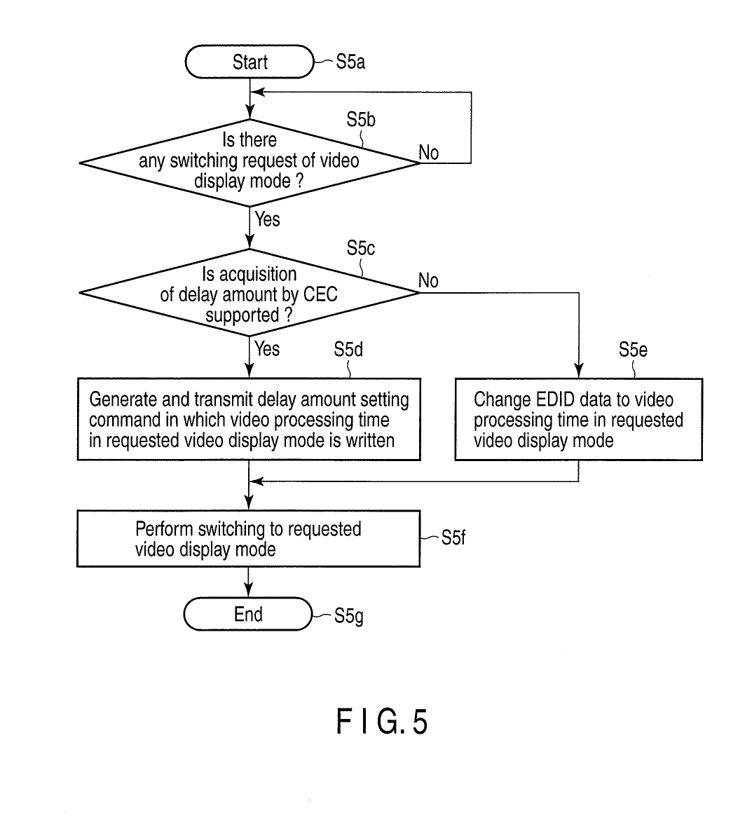

FIG. 5 shows a flowchart summarizing the processing operation to output information indicating the time required for video signal processing by the digital television broadcast-receiving apparatus 13 to the audio reproduction apparatus 12 in the form of a device control signal. That is, if processing is started (step S5a), in step S5b, the controller 47 determines whether switching of the video display mode is requested and if the controller 47 determines that switching is requested (YES), in step S5c, the controller 47 determines whether the audio reproduction apparatus 12 supports acquisition of the delay amount by CEC.

If the audio reproduction apparatus 12 is determined to support acquisition of the delay amount by CEC (YES), in step S5d, the controller 47 causes the CEC controller 54b to generate a delay amount setting command in which information indicating the time required for video signal processing in the requested video display mode is written and transmits the delay amount setting command to the CEC line 15c of the HDMI cable 15.

If, in step S5c, the audio reproduction apparatus 12 is determined not to support acquisition of the delay amount by CEC (NO), in step S5e, the controller 47 changes EDID data to information indicating the time required for video signal processing in the requested video display mode. Then, after step S5d or S5e, in step S5f, the controller 47 performs switching to the requested video display mode before terminating the processing (step S5g).

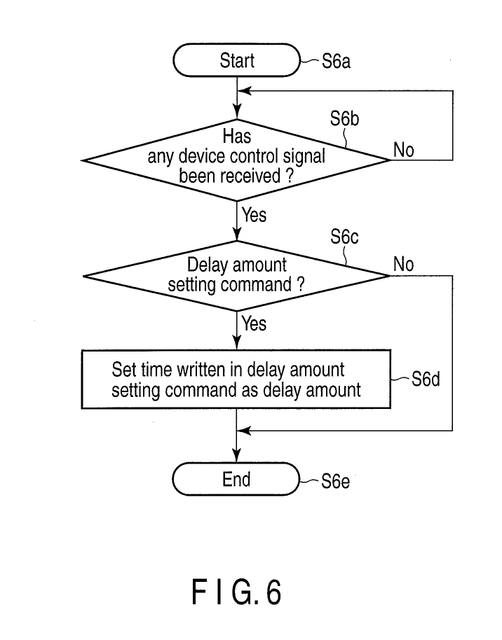

FIG. 6 shows a flowchart summarizing the processing operation to set the delay amount of an audio signal after the audio reproduction apparatus 12 receives a delay amount setting command output from the digital television broadcast-receiving apparatus 13. That is, if processing is started (step S6a), in step S6b, the controller 59 determines whether a device control signal has been received.

If the controller 59 determines that a device control signal has been received (YES), in step S6c, the controller 59 determines whether the received device control signal is a delay amount setting command. If the signal is determined not to be a delay amount setting command (NO), the controller 59 terminates the processing (step S6e). If, in step S6c, the signal is determined to be a delay amount setting command (YES), in step S6d, the controller 59 sets the time written in the delay amount setting command to the audio delay processing module 58 as the delay amount and terminates the processing (step S6e).

According to the above embodiment, information indicating the time required for video signal processing by the digital television broadcast-receiving apparatus 13 is transmitted to the audio reproduction apparatus 12 as a command defined for the device control signal transmitted via the CEC line 15c without using EDID data.

Thus, even if the video display mode of the digital television broadcast-receiving apparatus 13 is changed and the time required for video signal processing is changed, the changed time can be transmitted to the audio reproduction apparatus 12. Accordingly, the audio reproduction apparatus 12 can synchronize the reproduced audio with the display video by delaying the reproduced audio in accordance with the changed time, making the handling convenient for the user to suit practical use.

In the above embodiment, “Standard mode”, “Movie mode”, and “Game mode” have been described as the video display modes prepared for the digital television broadcast-receiving apparatus 13, but the video display modes are not limited to the above example and, for example, “Delegation mode” in which the brightness and hues are automatically changed in accordance with display video and “Vivid mode” in which color shades are more vivid than the standard mode may be prepared.

Further, “2D/3D conversion mode” in which a video signal for plane (two-dimensional) display is converted into a video signal for stereoscopic (three-dimensional) display, “3D/2D conversion mode” in which a video signal for stereoscopic (three-dimensional) display is converted into a video signal for plane (two-dimensional) display, and “quad-speed reproduction mode” may be prepared.

In short, if a change of the operation mode that causes a change of the time required for video signal processing is made in the digital television broadcast-receiving apparatus 13, output of time information required for video signal processing corresponding to the changed operation mode as a delay amount setting command via the CEC line 15c is enough.

In the above embodiment, when the change of the video display mode is requested, a delay amount setting command is generated by the digital television broadcast-receiving apparatus 13 and transmitted, but the embodiment is not limited to this and, for example, the audio reproduction apparatus 12 may request acquisition of the current video signal processing time from the digital television broadcast-receiving apparatus 13 at a predetermined timing.

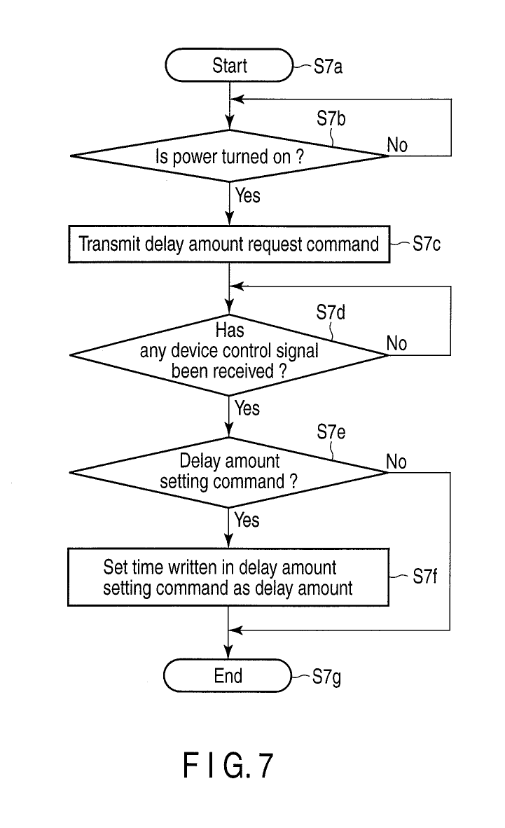

FIG. 7 shows a flowchart summarizing the processing operation in which the audio reproduction apparatus 12 requests acquisition of the video signal processing time from the digital television broadcast-receiving apparatus 13. That is, if processing is started (step S7a), in step S7b, the controller 59 determines whether power is turned on.

If power is determined to be turned on (YES), in step S7c, the controller 59 transmits an acquisition request of information indicating the time required for the video signal processing to the digital television broadcast-receiving apparatus 13 via the CEC line 15c. More specifically, the audio reproduction apparatus 12 transmits, for example, a delay amount request command <Get LipSync time> as <Vender Command> defined for the device control signal to the digital television broadcast-receiving apparatus 13 via the CEC line 15c.

Then, in step S7d, the controller 59 determines whether a device control signal has been received and if the controller 59 determines that a device control signal has been received (YES), in step S7e, the controller 59 determines whether the received device control signal is a delay amount setting command. If the received device control signal is determined not to be a delay amount setting command (NO), the controller 59 terminates the processing (step S7g). If, in step S7e, the received device control signal is determined to be a delay amount setting command (YES), in step S7f, the controller 59 sets the time written in the delay amount setting command to the audio delay processing module 58 as the delay amount and terminates the processing (step S7g).

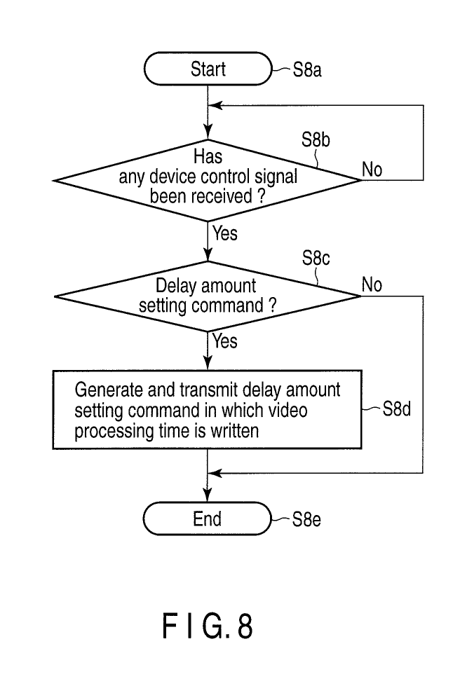

FIG. 8 shows a flowchart summarizing the processing operation in which the digital television broadcast-receiving apparatus 13 transmits the video signal processing time to the audio reproduction apparatus 12 after receiving an acquisition request of the video signal processing time from the audio reproduction apparatus 12. That is, if processing is started (step S8a), in step S8b, the controller 47 determines whether a device control signal has been received.

If the controller 47 determines that a device control signal has been received (YES), in step S8c, the controller 47 determines whether the received device control signal is a delay amount request command. If the signal is determined not to be a delay amount request command (NO), the controller 47 terminates the processing (step S8e). If, in step S8c, the signal is determined to be a delay amount request command (YES), the controller 47, in step 8d, generates a delay amount setting command in which information indicating the time required for video signal processing is written and transmits the command to the audio reproduction apparatus 12 via the CEC line 15c before terminating the processing (step S8e).

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A video display apparatus comprising:
a generation module configured to generate a device control signal when a change of an operation mode that changes the time required for the video signal processing is requested, the device control signal indicating a time when video signal processing in a requested operation mode is to be written;
a transmitting module configured to transmit the device control signal generated by the generation module via a transmission line to cause an audio reproduction apparatus to set a delay amount associated with an audio reproduction; and
a connection to an audio reproduction apparatus configured to perform the audio reproduction after the audio signal is output from an information output apparatus,
wherein the video display apparatus is configured to display video after a video signal output from the information output apparatus is received, the video display apparatus mutually controllably connected with the information output apparatus by the device control signal, the information output apparatus being configured to output the video signal and an audio signal that are mutually synchronized.

2. The video display apparatus of claim 1, wherein the video display apparatus is configured to perform digital signal transmission conforming to an HDMI standard, and
the generation module is configured to generate the device control signal in which the information indicating the time required for the video signal processing is written as a command transmitted via a CEC line, the command further comprising a LipSync value indicating the time required for the video signal processing.

3. A video display method performed by a video display apparatus, comprising:
generating a device control signal when a change of the operation mode that changes the time required for the video signal processing is requested, the device control signal indicating a time when video signal processing in a requested operation mode is to be written; and
transmitting the generated device control signal via a transmission line to cause an audio reproduction apparatus to set a delay amount associated with an audio reproduction,
wherein the video display apparatus displays video after a video signal output from the information output apparatus is received, and wherein the video display apparatus is mutually controllably connected with the information output apparatus by a device control signal, and wherein the information output apparatus outputs the video signal and an audio signal that are mutually synchronized.

4. An audio reproduction apparatus comprising:
a determination module configured to determine whether a device control signal comprises information indicating a time required for video signal processing of a video display apparatus; and
a setting module configured to set a delay amount of an audio reproduction based on the information indicating the time when the determination module determines that the information indicating the time required for the video signal processing of the video display apparatus is written,
wherein the audio reproduction apparatus is configured to perform audio reproduction after an audio signal output from an information output apparatus is received, the audio reproduction apparatus mutually controllably connected with the information output apparatus by a device control signal, the information output apparatus configured to output a video signal and the audio signal that are mutually synchronized, the audio reproduction apparatus configured to communicate with a video display apparatus configured to make a video display after receiving the video signal output.

5. The audio reproduction apparatus of claim 4, wherein the audio reproduction apparatus is configured to perform digital signal transmission conforming to an HDMI standard, and
the determination module configured to receive the device control signal in which the information indicating the time required for the video signal processing is written as a command transmitted via a CEC line, the command further comprising a LipSync value indicating the time required for the video signal processing.

6. An audio reproduction method, performed by an audio reproduction apparatus, the method comprising:
determining whether information indicating a time required for video signal processing of the video display apparatus is written in a device control signal received via a transmission line of the device control signal; and
setting a delay amount of an audio reproduction based on the information indicating the time when it is determined that the information indicating the time required for the video signal processing of the video display apparatus is written,
wherein the audio reproduction apparatus performs audio reproduction after an audio signal output from an information output apparatus is received, wherein the audio reproduction apparatus is mutually controllably connected with the information output apparatus by a device control signal, wherein the information output apparatus outputs a video signal and the audio signal that are mutually synchronized, and wherein the audio reproduction apparatus communicates with a video display apparatus making a video display after receiving the video signal output.

7. A video/audio synchronization control system comprising:
a generation module configured to cause the video display apparatus to generate a device control signal when a change of the operation mode that changes the time required for the video signal processing is requested, the device control signal indicative of a time when video signal processing in a requested operation mode is to be written;
a transmitting module configured to cause the video display apparatus to transmit the device control signal generated by the generation module via a transmission line to cause an audio reproduction apparatus to set a delay amount of the audio reproduction;
a determination module configured to cause the audio reproduction apparatus to determine whether the device control signal comprises information indicating the time required for the video signal processing of the video display apparatus, the device control signal received via the transmission line; and
a setting module configured to cause the audio reproduction apparatus to set the delay amount of the audio reproduction based on the information indicating the time when the determination module determines that the information indicating the time required for the video signal processing of the video display apparatus is written,
wherein the information output apparatus is configured to output a video signal and the audio signal that are mutually synchronized, wherein the video signal received by a video display apparatus after the video signal is output from the information output apparatus, and wherein the information output apparatus is mutually controllably connected with an audio reproduction apparatus by the device control signal.

8. The video/audio synchronization control system of claim 7, wherein the system is configured to perform digital signal transmission conforming to an HDMI standard, and
the generation module is configured to generate the device control signal in which the information indicating the time required for the video signal processing is written as a command transmitted via a CEC line, the command further comprising a LipSync value indicating the time required for the video signal processing.
